(19) United States
(12) Patent Application Publication
(10) Pub. No.: US 2007/0116309 A1
(43) Pub. Date: May 24, 2007

(54) Earpiece with extension

(76) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/411,314

(22) Filed: Apr. 26, 2006

Related U.S. Application Data
(63) Continuation-in-part of application No. 11/247,105, filed on Oct. 11, 2005.

(51) Int. Cl. H04R 25/00

(52) U.S. Cl. 381/313

(57) ABSTRACT

An earpiece having at least one flanged extension or a resilient member or substance is disclosed. The earpiece can be used to mitigate exposure to ambient sound. The earpiece can also be used to provide sound from a two-way radio or the like to a user's eardrum. Combinations of these two applications are possible. Thus, ambient sound can be attenuated while sound from a radio is enhanced. A controlled amount of ambient sound can be allowed to reach a user's eardrum. This may be desirable, for example, when it is necessary for a user to hear conversations or other comparatively lower lever sounds.

### PRIORITY CLAIM

This patent application is a continuation-in-part (CIP) patent application of U.S. patent application Ser. No. 11/247,105, filed on Oct. 11, 2005, and entitled EARPIECE WITH FLANGED EXTENSION (docket no. M-15744 US), the entire contents of which are hereby expressly incorporated by reference.

### BACKGROUND

It is well known that high levels of ambient noise can cause hearing loss. Hearing protection for use in noisy environments is well known. Hearing protection is commonly used in such noisy environments as manufacturing facilities, warehouses, construction sites, shooting ranges, battlefields, and airports. Typically, any time that loud machinery is being operated, guns are being fired, or any other source of excessive noise is present, hearing protection is desirable so as to reduce discomfort and so as to conserve hearing. Hearing protection can lower the level of sound substantially before it reaches the eardrum. Thus, hearing protection can mitigate damage to the ear.

Contemporary hearing protection typically comprises either a noise reducing headset or earplugs. Headsets have cups or earpieces that generally surround the outer ear and reduce the level of noise that is incident thereon. Earplugs, by way of contrast, are inserted into the ear canal, where they reduce the level of sound transmitted therethrough to the eardrum. Both headsets and earplugs have proven effective in conserving hearing.

Thus, contemporary headsets are generally effective in reducing noise exposure. However, they suffer from deficiencies that tend to make them unsuitable for some applications. Headsets are bulky. They cannot be worn in environments where they may get in the way and they cannot be worn under helmets. Headset may be knocked off of a person's head by items in the wearer's environment.

Headsets often become uncomfortable after being worn for an extended period of time. Because of this, wearers may discontinue their use, i.e., remove a headset, while they remain within a noisy environment. Wearers may alternatively stretch the earpieces of the headset apart from one another, so that they do not apply as much pressure to the sides of the head. This may be done in an attempt to decrease discomfort. However, when the pressure is reduced in this manner, then the earpieces may not seal properly and thus may permit the introduction of excessive sound. They are also more readily knocked off of the user's head by items in the environment. In either instance, noise exposure is undesirably increased and the likelihood of hearing loss is undesirably increased.

Contemporary earplugs can also be effective. However, they can similarly become uncomfortable when worn for extended periods of time. Further, earplugs frequently tend to work loose during usage, thus reducing their effectiveness. They may even fall out. Of course, when they fall out the earplugs provide no protection at all. Further, they may be lost, so that they cannot subsequently be re-inserted.

Earpieces for use with two-way radios are well known. Law enforcement, security, and military personnel frequently wear earpieces that fit into the conchae bowl of the ear so as to facilitate listening to two-way radios and the like. Such earpieces are different from earplugs in that they are intended to allow some sound to enter the ear. These earpieces are attached via acoustic tubing to a small speaker. Communications received by a two-way radio are reproduced by the speaker. Sound then travels through the acoustic tubing to the user's ear, where the end of the acoustic tubing is held in place by the earpiece. In this manner, communications received by the two-way radio can be heard without letting others nearby hear the communications as well.

The sound output port or opening of such contemporary earpieces is further away from the eardrum than is sometimes desirable. Such positioning of the sound output port necessitates that the volume of the speaker be increased more than would be required if the sound output port were closer to the eardrum. When the volume of the speaker is increased, the likelihood of another person hearing the communication is undesirably increased.

Thus, having the volume of the speaker at such an increased level may result in the undesirable disclosure of information and/or may dangerously give away a covert operative. During covert operations it is usually desirable to for a wearer to remain unobtrusive. Thus, it is undesirable for others to be able to hear the wearer's radio.

In some instances the speaker may be incapable of delivering the desired volume. This is particularly true where the earpiece is being used by the hearing impaired or in a noisy environment. It may also be true when the speaker simply lacks sufficient output power.

Thus, although such contemporary earpieces are generally suitable for their intended purposes, they suffer from inherent deficiencies that tend to detract from their overall usefulness. It is therefore desirable to provide an earpiece that provides protection from noise exposure while being comfortable to wear for extended periods of time and while not tending to work its way loose or otherwise become less effective. It is also desirable to provide an earpiece that provides sound closer to the eardrum, so that the sound produced by the speaker is more easily heard and so that reduced volume can be advantageously utilized, such as in covert situations.

### SUMMARY

A device for mitigating sound exposure and/or facilitating communication is disclosed. According to one embodiment of the present invention, the device comprises an earpiece and an extension formed to the earpiece. The extension can be integrally formed with respect to the earpiece, or can be attached (either removably or non-removably) thereto. The extension can be solid, so as to mitigate sound exposure. The extension can alternatively have a bore formed therethrough so as to facilitate the transmission of sound (such as ambient sound or sound from a device such as a two-way radio).

When the extension comprises a bore, a sound output port can be configured so as to be positioned proximate a user's eardrum when the earpiece is worn, so that sound is more effectively provided to the eardrum and consequently the volume of a two-way radio or the like can be substantially reduced. The device can be configured so as to mitigate undesirable exposure to harmful ambient sound while allowing desirable ambient sound (such as conversations) to be heard.

More particularly, the device can comprise an earpiece that is configured to be disposed at least partially within a conchae and an extension that is formed to the earpiece, wherein the extension is configured to be disposed at least partially within an ear canal. The extension can comprise one or more flanges. Each flange tends to seal the ear canal so as to mitigate the communication of sound therethrough in either direction. Thus, protection from excessive ambient sound is provided to the wearer and the ability for others to hear radio communications is mitigated.

The earpiece defines the amount of the extension that is inserted into a wearer's ear canal. That is, the earpiece determines just how far the extension is inserted into the wearer's ear. This, in turn, determines the position of the sound output port at the distal end of the extension with respect to the eardrum. Thus, the combination of the earpiece and the extension can define a device wherein the sound output port is close enough to the eardrum so as to allow the volume of the radio to be substantially reduced and/or so as to allow the radio to be heard in noisy environments.

A filter, such a Hoch filter, can be placed in acoustic communication with a bore of the extension so as to help determine what sounds are communicated to a wearer's eardrum. For example, the filter can be placed within the bore of the extension, proximate where the extension attaches to the earpiece.

The earpiece and the extension can be configured for use in a human ear. Alternatively, the earpiece and the extension can be configured for use in a non-human ear. For example, the earpiece and the extension can be configured for use in a canine ear, so as to provide hearing protection for the canine and/or so as to facilitate the use of radio voice command for the canine. Other non-human applications of the present invention are similarly contemplated.

According to at least one embodiment, the earpiece comprises a generally arcuate rib having upper and lower ends and a generally straight rib extending substantially between the upper and lower ends. An upper lobe can be formed at the upper end of the arcuate rib and a lower lobe can be formed at the lower end of the arcuate rib. The earpiece is configured to be captured by protrusions of the conchae. Since the earpiece is held in place by anatomical structures of the ear, the earpiece and extension are not likely to work their way loose and/or fall out of the ear.

However, configurations of the earpiece are likewise suitable. As those skilled in the art will appreciate, other configuration of the earpiece can be used to prevent the extension from inadvertently falling out of the ear canal and can also be used to determine how far the extension is inserted into the ear canal.

The arcuate rib can be configured so as to bend in order to accommodate a large range of ear sizes. For example, the earpiece can be configured to fit at about 70% of the ears of men between 19 and 40 years old.

This invention will be more fully understood in conjunction with the following detailed description taken together with the following drawings.

### BRIEF DESCRIPTION OF THE DRAWINGS

FIG. 1 is a perspective view of an earpiece having a flanged extension according to a first embodiment of the present invention;

FIG. 2 is a perspective view of the extension of the earpiece of FIG. 1 wherein the extension is removed from the earpiece;

FIG. 3 is a perspective view of one alternative embodiment of the extension of FIG. 2, wherein openings are formed in the flanges thereof;

FIG. 4 is a perspective view of another alternative embodiment of the extension of FIG. 2, wherein openings are formed in the stem thereof;

FIG. 5 is a perspective view of the extension of FIG. 2, showing a Hoch's filter inserted therein;

FIG. 6 is a side view of the earpiece of FIG. 1, wherein the extension is removed therefrom;

FIG. 7 is a bottom view of the earpiece of FIG. 6, showing the aperture therein with dashed lines;

FIG. 8 is a perspective view of an earpiece having a flanged extension according to a second embodiment of the present invention;

FIG. 9 is a perspective view of the extension of the earpiece of FIG. 8 wherein the extension is removed from the earpiece;

FIG. 10 is a perspective view of the earpiece of FIG. 1 having acoustic tubing attached thereto;

FIG. 11 is a perspective view of the flanged extension of FIG. 1, showing the Hoch filter exploded therefrom and also showing a flexible skin (dashed lines) formed partially thereover;

FIG. 12 is a perspective view of a flanged extension having three flanges, according to an embodiment of the present invention;

FIG. 13 is a perspective view of a flanged extension having four flanges, according to an embodiment of the present invention;

FIG. 14 is a perspective view of a foam, fiber, or fabric extension, according to an embodiment of the present invention;

FIG. 15 is a side view of a foam, fiber, or fabric extension having a sound transmissive bore formed therethrough according to an embodiment of the present invention, the bore being shown in dashed lines;

FIG. 16 is a side view of a tapered foam, fiber, or fabric extension, according to an embodiment of the present invention;

FIG. 17 is a side view of an extension that is not inserted substantially into the ear canal, according to an embodiment of the present invention; and

FIG. 18 is a perspective view of two earpieces with extensions having a lanyard interconnecting them according to one embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE PREFERRED EMBODIMENTS

The present invention comprises an earpiece with a flanged extension that is suitable for use as hearing protection, is suitable for facilitating listening to a two-way radio or the like, or is suitable for providing a combination of hearing protection and such listening. The present invention may comprise a solid extension so as to substantially attenuate ambient sound. Alternatively, the present invention may comprise a hollow or partially hollow extension so allow at least some ambient sound or sound from a radio to pass therethrough.

According to one aspect of the present invention, an earpiece is held in place by anatomical structures of the ear and the earpiece holds the extension in place within the ear canal. That is, the earpiece prevents the extension from loosening or falling out of the ear canal.

According to another aspect of the present invention, the earpiece positions a sound port at the distal end of the extension near the eardrum, so that the volume of a two-way radio can be reduced. That is, the earpieces determines how far into the ear the extension extends.

Various combinations of sound attenuation and sound transmission may be provided. For example, a hollow or partially hollow extension may be configured so as to substantially attenuate some ambient sound (such as potentially harmful loud noise), while allowing some ambient sound (such as voices) to be heard. Optionally, the extension can comprise one or more openings that allow a substantial portion of ambient sound to be heard, while also allowing radio communications to be heard. Optionally, a filter may be used to selectively allow sounds to be heard.

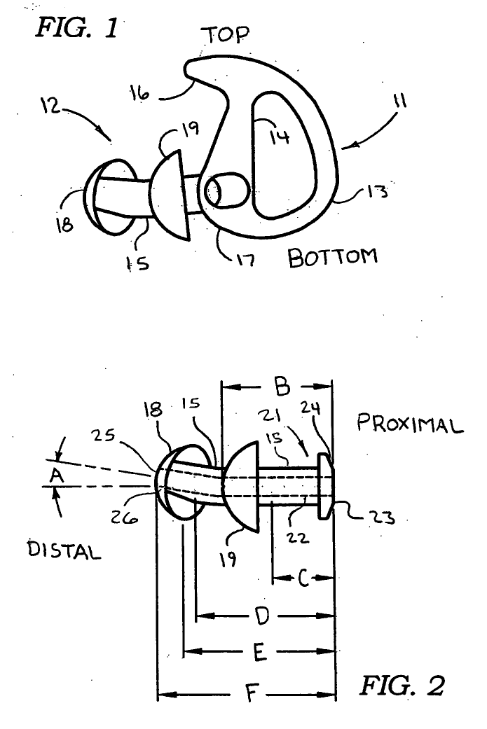

Referring now to FIGS. 1, 2, 6, and 7, one embodiment of the present invention comprises an earpiece 11 to which an extension 12 is attached. Earpiece 11 is configured to be disposed in the conchae of the outer ear. Extension 12 is configured to be disposed within the ear canal.

Earpiece 11 can comprise a generally arcuate rib 13 that has upper and lower ends. Arcuate rib 13 can be attached to a straight rib 14 at the upper and lower ends of arcuate rib 13. An upper lobe 16 can be formed proximate where arcuate rib 13 and straight rib 14 join at the top of earpiece 11. Similarly, a lower lobe 17 can be formed proximate where arcuate rib 13 and straight rib 14 join at the bottom of earpiece 11.

Earpiece 11 is configured to be disposed and held in place within the conchae of a human ear. More particularly, the crus and the antihelix of a wearer's ear cooperate to capture upper lobe 16 and the tragus and antitragus cooperate to capture lower lobe 17. The antihelix and the antitragus cooperate to capture arcuate rib 13. Thus, earpiece 11 is configured to be captured by protrusions of the conchae. In this manner, earpiece 11 is held firmly in place within the conchae and can therefore maintain extension 12 in a desired position within the ear canal.

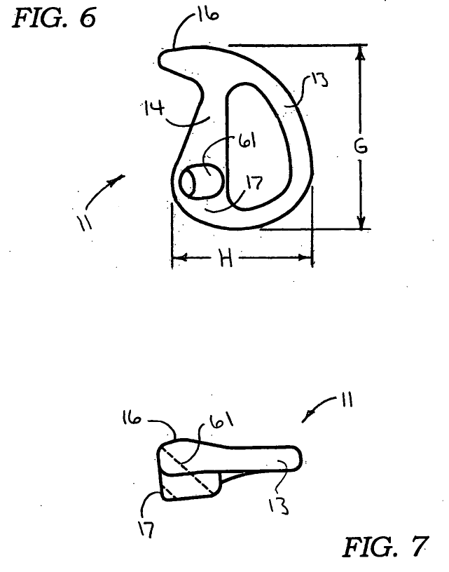

Extension 12 can be either removably or permanently attached to earpiece 11. Extension 12 can be removably attached to earpiece 11 by friction fit, by detents, by threads, or by any other desired means. For example, extension 12 can be friction fit to earpiece 11 by sizing a proximal portion 21 (FIG. 2) of extension 12 so as fit tightly within an aperture 61 (FIG. 6) of earpiece 11.

Extension 12 can be permanently attached to earpiece 11 by adhesive bonding, ultrasonic welding, or by any other desired means. Alternatively, extension 12 can be integrally formed to earpiece 11, such as by injection molding earpiece 11 and extension 12 within a common mold cavity. Thus, earpiece 11 and extension 12 can be formed either integrally or separately.

Earpiece 11 and extension 12 can be formed of a soft, resilient material to enhance comfort during use. Both earpiece 11 and extension 12 can be formed of the same material. For example, earpiece 11 and extension 12 can be formed of a resilient polymer, such as silicon rubber. Earpiece 11 and extension 12 can be formed of a material having a Shore A durometer of between 35 and 45, such as a Shore A durometer of approximately 40.

Earpiece 11 functions as a stop to prevent extension 12 from being inserted too far into the ear. Earpiece 11 also prevents extension 12 from being inadvertently removed or loosened from the ear. The length of extension 12 determines, at least in part, how close the tip thereof is positioned with respect to the eardrum.

With particular reference to FIG. 2, according to one embodiment of the present invention extension 12 comprises a stem 15 and two flanges, 18 and 19. Extension 12 can comprise any desired number of flanges, including no flanges at all, as discussed in further detail below. Stem 15 can either be solid (so as to substantially block sound) or hollow (so as to substantially transmit sound). Stem 15 can also be partially hollow (so as to selectively transmit sound).

Stem 15 can bend such that it angles upwardly to conform to the upward angle of the human ear canal. For example, stem 15 can bend such that it angles upwardly at an angle, Angle A, of approximately 30°. The distance between the proximal end of extension 12 and the distal end of outer flange 19, Dimension B, can be approximately 0.545 inch. The distance between the proximal end of extension 12 and the point where a filter (such as a Hoch filter) ends, Dimension C, can be approximately 0.304 inch. The distance between the proximal end of extension 12 and the bend in stem 15, Dimension D, can be approximately 0.680 inch. The distance between the proximal end of extension 12 and a distal end of inner flange 18, Dimension E, can be approximately 0.743 inch. The distance between the proximal end of extension 12 and the distal end of inner flange 18, Dimension F, can be approximately 0.870 inch.

The diameter of stem 15 can be approximately 0.189 inch. Stem 15 can optionally have a bore 22 formed therethrough. Bore 22 can have a diameter of approximately 0.094 inch. Outer flange 19 can have a radius of approximately 0.241 inch. Similarly, inner flange 18 can have a radius of approximately 0.193 inch. Thus, the radius of inner flange 18 can be substantially less than the radius of outer flange 19, so as to better accommodate the manner in which the human ear canal becomes narrower as it gets deeper.

The exemplary angle and dimensions discussed above provide a single extension that is suitable for use with a large number individuals. Those skilled in the art will appreciate that other dimensions are likewise suitable.

The distal end of bore 22 defines a sound output port 26 (FIGS. 2 and 9). Extension 12 is configured such that sound output port 26 is positioned proximate the wearer's eardrum. That is, extension 12 can be configured so as to position a distal end 25 thereof proximate the eardrum. In this manner, sound transmitted through bore 22 (such as sound from a two-way radio), is brought close to the eardrum such that the volume of the sound required can be substantially reduced. For example, the extension can position sound output port 26 within one, two, or three millimeters of the eardrum. The extension can have a length of approximately ½ inch. The extension can have a length of ⅝ inch or more.

A head 23 can be formed upon the proximal end of stem 15 so as to enhance friction with respect to aperture 61 of earpiece 11 and/or so as to define detents that tend to keep extension 12 attached to earpiece 11. Bevels 24 can optionally be formed upon head 23 to better facilitate insertion of head 23 through aperture 61.

The extension may comprise a flanged extension, having flanges as shown in FIGS. 2-5 and 8-11. The flanges generally fill (close off) the ear canal and tend to block ambient sound. Although sometimes it is desirable to block ambient sound, other times, it is desirable for the user to hear ambient sound. Thus, the flanges can have opening formed therein, as discussed below. Although two flanges are shown, the extension may comprise more or less flanges. For example, the extension may comprise three, four, five, six, or more flanges. The flanges need not be identical, but rather may vary in size, shape, orientation and/or positions of attachment to the stem, for example.

The extension can have a bore formed therethrough to facilitate the transmission of sound from a speaker (such as via acoustic tubing connected to the speaker) to the user's eardrum. Alternatively, the extension can lack such a bore, so as to define an earplug, such as for attenuating ambient sound. Indeed, the bore and/or openings in the stem and/or flanges can be configured so as to selectively transmit and block desired sounds. Such selectivity can be based upon the frequency and/or intensity of the sound.

A user can wear one earpiece having an extension with a bore and one earpiece lacking a bore. The earpiece having an extension with a bore facilitates listening to a radio, while the earpiece having an extension without a bore at least partially blocks distracting and/or potentially harmful ambient sound.

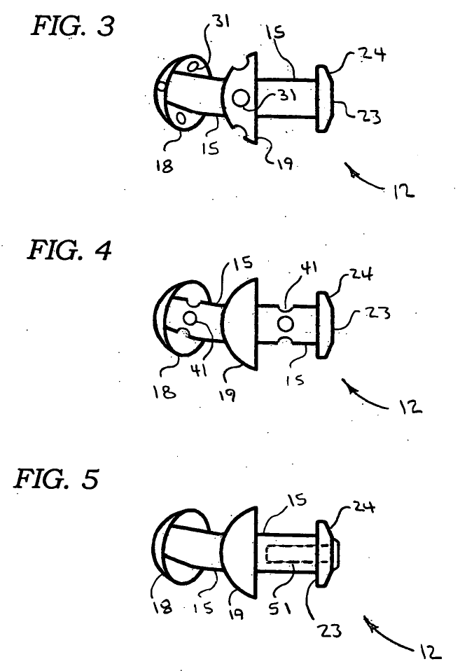

Referring now to FIG. 3, flanges, 18 and 19, of extension 12 can optionally have one or more openings 31 form therein. For example, each flange, 18 and 19, can have one, two, three, or four openings 31 formed therein. Openings 31 can be holes. Alternatively, the openings 31 can be cutouts, such as notches formed in the flanges. The openings allow at least some ambient sound to better reach the user's eardrum.

Such openings 31 may be desirable when the present invention is intended to facilitate listening to a two-way radio and when it is also desirable to hear ambient sound. For example, such openings 31 may be desirable in police applications where a police officer is required to hear both the two-way radio and face-to-face conversations.

Referring now to FIG. 4, one or more openings 41 can be formed in stem 15, such as intermediate or proximate flanges, 18 and 19. A curable polymer material suitable for use in the ear canal can be injected into the tube such that it substantially fills the tube and/or at least some space between the flanges. That is, the injected polymer material extrudes from the openings and tends to fill in the space intermediate the flanges. This injection may be accomplished with the extension inserted into a wearer's ear canal, so as to provide a custom fit. Alternatively, this injection may be performed using an artificial ear canal, such as for mass production.

Silicon rubber may be used as the extrudeable material. Generally, any extrudeable material suitable for use as earplugs can be used. In this fashion, attenuation of ambient sound is enhanced. Such earplugs are suitable for use in gun ranges and noisy industrial environments.

The opening at the distal end of the tube can optionally be closed to prevent leakage of the injected polymer material therefrom. A skin may be formed over the flanged extension to trap the polymer material and/or to facilitate easier insertion into the ears. Alternatively, the openings can be omitted and the central bore of the tube can still be filled with polymer material to attenuate sound.

Referring now to FIG. 5, a filter 51 can be inserted into bore 22 to selectively mitigate sound exposure. For example, a Hoch filter can be used to mitigate exposure to louder sounds, while still allowing a wearer to hear quieter sounds, such as speech.

Referring now to FIGS. 6 and 7, an earpiece 11 that is configured for use in the left ear is shown with the extension removed therefrom. Arcuate rib 13 and straight rib 14 define a D shape. When a mirror image arcuate rib and straight rib are configured for use in the right ear, a reverse (mirror image) D is similarly defined.

For a medium size earpiece, the height, Dimension G, can be approximately 1.087 inch and the width, Dimension H, can be approximately 0.802 inch. For a large size earpiece, the height, Dimension G, can be approximately 1.150 inch and the width, Dimension H, is approximately 0.850 inch. The medium size fits a large percentage of people.

The medium size earpiece can be configured to fit most adult ears. More particularly, the medium size earpiece can be configured to fit at least 70% of ears of men between 19 and 40 years old. Arcuate rib 13 tends to deform or bend so as to accommodate a wide range of ear sizes.

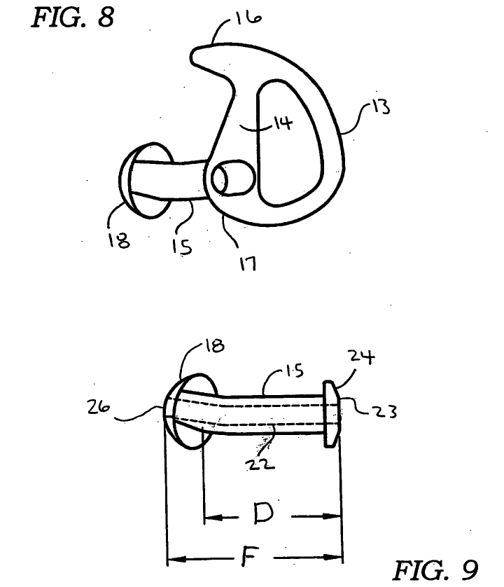

Referring now to FIGS. 8 and 9, outer flange 19 can optionally be omitted. Indeed, as mentioned above, extension 15 can comprise any desired number of flanges, including no flanges. In some instances, a single flange may perform adequately. This is particularly true when it is desirable to allow the wearer to hear ambient sound. Omitting the other flange(s) better allows ambient sound to be heard. In some applications, the primary reason for wearing the earpiece may be to allow the wearer to better hear radio communications. Positioning output port 26 close to the eardrum accomplishes this goal.

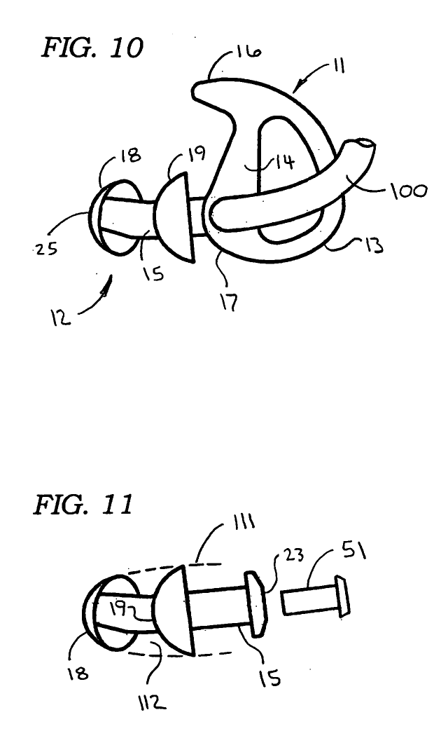

Referring now to FIG. 10, an acoustic tube 100 can be attached to earpiece 11 and/or extension 12 such that a generally continuous bore is defined for sound to travel though from a speaker to the eardrum. A barbed metal or plastic fitting can be used to accomplish such attachment. Other methods of attachment, such as the use of adhesive bonding and/or ultrasonic welding, are likewise suitable.

Since the distal end 25 of extension 12 can be placed close to a wearer's eardrum, the volume of a two-way radio or other device (such as a cellular telephone, CD player, MP3 player, etc.) can be substantially reduced. With the volume reduced, sound advantageously cannot be as easily heard by others. Thus, during covert operations, for example, the likelihood of someone other than the wearer undesirably hearing sound from a two-way radio is substantially mitigated. By reducing the sound volume, smaller, less powerful, and/or less expensive speakers can be used. Placing the sound closer to the eardrum can make it easier for the hearing impaired to hear.

Sound transmissive embodiments of the present invention (such as those embodiments having a bore 22 formed through stem 15) can similarly be used with a variety of personal electronic devices that produce sound, including two-way radios, cellular telephones, MP3 players, CD players, cassette players, personal digital assistants (PDAs), desktop computers, laptop computers, notebook computers, pocket PCs, and hearing aids.

Referring now to FIG. 11, according to another embodiment of the present invention extension 15 comprises one or more flanged members, 18 and 19 (similar to those of FIGS. 5, 6, and/or 7), having a skin or covering 111 formed thereover. Covering 111 can be formed of a thin resilient material, such as rubber, such as that which common balloons are formed of. Optionally, foam or gel 112 can be disposed between the covering 111 and flanged members 18 and 19. Foam or gel 112 can comprise a biocompatible material, such as a silicon. Foam or gel 112 can extend proximal of outer flange 19, if desired.

Foam or gel can be injected between covering 111 and flanged members, 18 and 19, through openings 41 (FIG. 4), as discussed above. Thus, such a covering 111 can be used with extension 12 shown in FIG. 4, where an extrudeable substance (which can be a foam or gel) is injected into bore 22 and passes through holes 21 to fill the void between the flanges, 18 and 19.

Thus, according to at least one embodiment of the present invention the extension can comprise a tube (such as stem 15) and a rubber skin or covering, wherein foam, gel, or some other resilient substance is disposed between the tube and the rubber skin. The present invention can optionally comprise one or more flanges. The tube can be formed of a flexible polymer material. However, the tube may alternatively be formed of a rigid polymer or metal material. The tube, foam, and skin can be attached to one another via any desired combination of friction fitting, adhesive bonding, and ultrasonic welding. The extension can be tapered to facilitate easy insertion into the ear canal and to provide a good fit therein.

One advantage of having more flanges is that the device is better secured in the ear. Another advantage of having more flanges, particularly if the flanges do not have holes formed therein, is that ambient sound is better mitigated before reaching a wearer's eardrum. Another advantage of having more flanges, particularly if the flanges do not have holes formed therein, is that the sound of the radio is better prevented from escaping from the ear, such that it may be undesirably heard by others.

Any of the flanged extensions disclosed herein can either be ambidextrous (formed to fit either the right or left ear), or can be dedicated to fit only one ear. Thus, the flanges can be either radially symmetric or can be asymmetric such that they tend to be optimized for a particular ear (left or right). They can also be optimized in configuration so as to better fit a particular person's ear.

According to one aspect, earpiece 11 is configured to fit multiple sizes of ears. More particularly, arcuate rib 13 is deformable so as to permit earpiece 11 to fit into smaller conchae bowls.

The hole 61 (FIG. 6) in earpiece 11 can be configured such that the flanged extension is positioned at the top of the ear canal, at the bottom of the ear canal, at one side of the ear canal, or is approximately centered in the ear canal. Configuring the hole such that the flanged extension is not approximately centered causes the flanged extension to be biased toward an inner surface of the ear canal and can help to keep the earpiece and extension in the ear.

However, as long as the earpiece and/or the flanges of the extension are sufficient to keep the earpiece and extension in the ear, then the flanged extension can be position approximately in the center of the ear canal. Positioning the flanged extension approximately in the center of the ear canal may be more comfortable for some wearers.

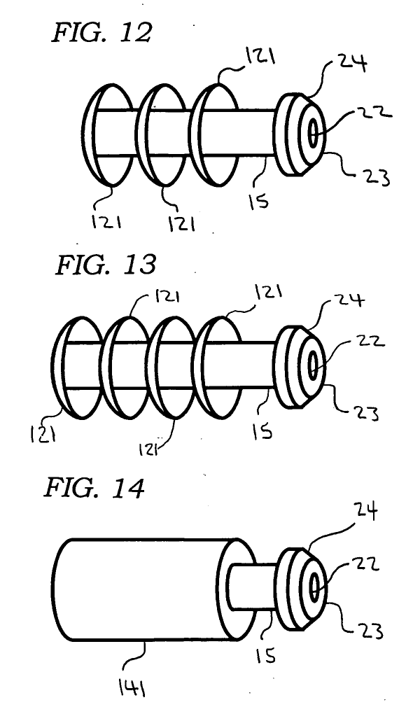

Referring now to FIG. 12, the extension can have three flanges 121 formed upon stem 15 thereof. As those skilled in the art will appreciate, the use of more flanges generally provides better sound reduction. The use of more flanges can also better secure the extension within the ear canal.

Referring now to FIG. 13, the extension can have four flanges 121 formed upon stem 15 thereof. Indeed, the extension can have any desired number of flanges formed upon stem 15 thereof.

The flanges of any embodiment of the present invention can be formed integrally with the stem. Alternatively, the flanges can be formed separately from the stem and can be formed of a different material with respect thereto.

Referring now to FIG. 14, stem 15 can be covered with a resilient substance such as foam, fiber, or fabric. Foam, such as a polymer foam, can be used to define a portion of the extension. The foam is compressed before or as it enters the ear canal. It then expends so as to effectively block at least a portion of the ear canal.

In a similar manner, fiber such as cotton, can be used to define a portion of the extension. For example, cotton can cover a portion of the extension in a manner similar to the way that cotton covers the end of a Q-Tip. Cotton fiber is sufficiently compressible and resilient so as to function in a manner similar to foam.

Fabric, such as woven cotton, can similarly be used to cover a portion of the extension. Any desired combination of foam, fiber, and fabric may be used. For example, cotton fabric can be used to cover cotton fiber.

Referring now to FIG. 16, the foam, fiber, or fabric can be tapered. Tapering the resilient substance makes it conform better to the shape of the ear canal. Tapering the resilient substance can make insertion thereof into the ear canal easier.

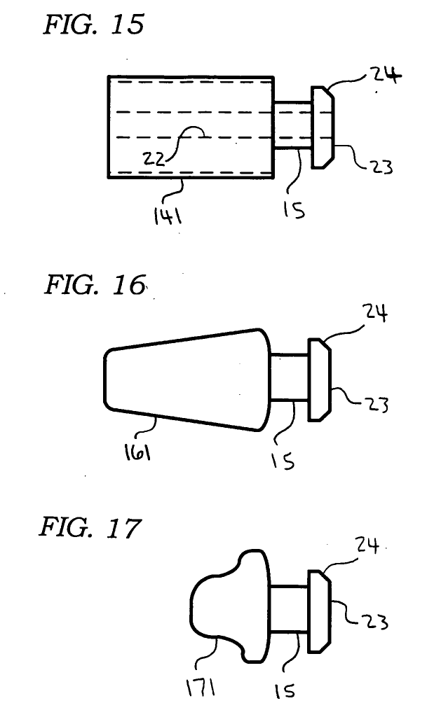

The resilient substance of FIGS. 14-16 can be formed over stem 15, as discussed above. Alternative, the resilient substance can be attached to head 23 or the like without being formed over a stem. For example, the resilient substance can be attached to a shorter stem that does not pass substantially therethrough. As a further example, the resilient material can be attached directly to head 23 or the like.

Any desired combination of flanges, foam, fiber, and fabric can be used to at least partially block the ear canal and thereby mitigate the transmission of sound therethrough. For example, the middle flange of the extension of FIG. 12 could be replace with a section of foam similar to the foam shown in FIG. 14.

The extension of any embodiment of the present invention can be bent as shown in FIGS. 1-5 and 9-11 so as to better conform to the shape of the human ear canal. Alternatively, the extension can be straight as shown in FIG. 12-15. If the extension is straight, it can be formed of a material that is bendable, so that the extension can conform, at least somewhat, to the shape of the human ear canal when inserted therein.

Referring now to FIG. 17, that portion 171 of the extension that is inserted into the ear canal can be formed such that it does not substantially enter the ear canal. The portion 171 can be formed of a rigid material or of a resilient substance. It can also be formed by providing a resilient layer over a substantially rigid material. It need only enter the ear canal far enough so as to be effective in mitigating the level of ambient sound reaching the eardrum.

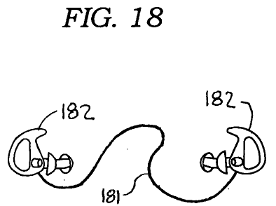

Referring now to FIG. 18, a lanyard 181 can be used to interconnect any embodiments of the earpiece with extension 182 of the present invention to one another and/or to any other item. For example, lanyard 18 can be used to connect two earpieces with extensions 182 to the wearer's clothing, e.g., shirt, jacket, hat, helmet, etc.

Lanyard 181 can interconnect two earpieces with extensions that are both configured as earplugs (both lack bores and are intended to mitigate sound exposure). Alternatively, one or both earpieces with extensions that are interconnected with a lanyard can be configured to transmit some sound, such as via the use of a bore for transmitting sound from a two-way radio or the like.

The number of flanges and/or the selection of resilient material can selectively determine the intensity and/or frequencies of ambient sound that is transmitted thereto to a wearer's eardrum. Thus, control over the ambient sound that is heard can be achieved. Desirable, lower intensity sounds can be readily transmitted to the eardrum, while harmful, higher intensity sounds are attenuated.

Although described herein a being for use in human ears, one or more embodiments of the present invention can also be used in non-human ears. For example, the present invention can be configured for canine ears, so as to mitigate noise exposure and/or facilitate communication with police or military dogs. As those skilled in the art will appreciate, such dogs are commonly exposed to noisy environments, such as those environments sometimes encountered in police work and on the battlefield. Further, it is frequently desirable to communicate with such dogs. Their ability to respond to radio commands has been established.

Thus, one or more embodiments of the present invention can mitigate noise exposure and/or facilitate communications. Noise exposure is mitigated by at least partially blocking the ear canal with an extension from an earpiece. Communications are facilitated by providing a passage for sound through the extension. The extension extends to a point proximate the eardrum, so that sound is delivered more directly to the eardrum. Thus, less volume is needed. The use of less volume is useful in covert operations. As stated above, it may also facilitate the use of smaller, less powerful, and/or less expensive speakers.

In view of the foregoing, the present invention provides sound protection and/or communications facilitation in a manner that is comfortable, unobtrusive (and thus suitable for covert use), and effective. The earpiece of the present invention is less likely to loosen or fall out as compared to contemporary earplugs. Positioning a sound output port close to the eardrum facilitates the use of lower two-way radio volumes, while at the same time better assuring that communications are heard.

Embodiments described above illustrate, but do not limit, the invention. It should also be understood that numerous modifications and variations are possible in accordance with the principles of the present invention. Accordingly, the scope of the invention is defined only by the following claims.

1. A device for mitigating communication of sound to a wearer's eardrum, the device comprising an earpiece and an extension that extends from the earpiece.

2. The device as recited in claim 1, wherein the earpiece is configured to be in a wearer's conchae and the extension is configured to be in a wearer's ear canal.

3. The device as recited in claim 1, wherein the extension is generally solid, so as to mitigate communication of sound therethrough.

4. The device as recited in claim 1, wherein the extension comprises at least one flange.

5. The device as recited in claim 1, wherein the extension comprises a plurality of flanges.

6. The device as recited in claim 1, wherein the extension comprises foam.

7. The device as recited in claim 1, wherein the extension comprises a solid stem that is covered with a resilient material.

8. The device as recited in claim 1, wherein the extension comprises one flange.

9. The device as recited in claim 1, wherein the extension comprises two flanges.

10. The device as recited in claim 1, wherein the extension comprises three flanges.

11. The device as recited in claim 1, wherein the extension comprises four flanges.

12. The device as recited in claim 1, wherein the extension comprises a solid stem that is covered with foam.

13. The device as recited in claim 1, wherein the extension comprises a solid stem that is covered with fiber.

14. The device as recited in claim 1, wherein the extension comprises a solid stem that is covered with fabric.

15. The device as recited in claim 1, wherein the extension is tapered.

16. The device as recited in claim 1, wherein the extension comprises a solid stem, resilient material generally covering the stem, and a covering generally covering the resilient material.

17. The device as recited in claim 1, wherein the extension comprises a solid polymer stem, resilient polymer material generally covering the stem, and a polymer covering generally covering the resilient polymer material.

18. The device as recited in claim 1, wherein the extension is configured to substantially enter the ear canal.

19. The device as recited in claim 1, wherein the extension is configured to not substantially enter the ear canal.

20. A device for selectively communicating sound to a wearer's eardrum, the device comprising an earpiece and an extension that extends from the earpiece.

21. The device as recited in claim 20, wherein the earpiece is configured to be in a wearer's conchae and the extension is configured to be in a wearer's ear canal.

22. The device as recited in claim 20, wherein the extension comprises a bore for communicating sound therethrough.

23. The device as recited in claim 20, wherein the extension comprises at least one flange.

24. The device as recited in claim 20, wherein the extension comprises a plurality of flanges.

25. The device as recited in claim 20, wherein the extension comprises foam.

26. The device as recited in claim 20, wherein the extension comprises a solid stem that is covered with a resilient material.

27. The device as recited in claim 20, wherein the extension comprises one flange.

28. The device as recited in claim 20, wherein the extension comprises two flanges.

29. The device as recited in claim 20, wherein the extension comprises three flanges.

30. The device as recited in claim 20, wherein the extension comprises four flanges.

31. The device as recited in claim 20, wherein the extension comprises a generally hollow stem that is covered with foam.

32. The device as recited in claim 20, wherein the extension comprises a generally hollow stem that is covered with fiber.

33. The device as recited in claim 20, wherein the extension comprises a generally hollow stem that is covered with fabric.

34. The device as recited in claim 20, wherein the extension is tapered.

35. The device as recited in claim 20, wherein the extension comprises a generally hollow stem, resilient material generally covering the stem, and a covering generally covering the resilient material.

36. The device as recited in claim 20, wherein the extension comprises a generally hollow polymer stem, resilient polymer material generally covering the stem, and a polymer covering generally covering the resilient polymer material.

37. The device as recited in claim 20, further comprising a Hochs filter configured so as to mitigate sound communicated through the extension.

38. The device as recited in claim 20, wherein the extension comprises a Hochs filter configured so as to mitigate sound communicated through the extension.

39. The device as recited in claim 20, wherein the extension is configured to substantially enter the ear canal.

40. The device as recited in claim 20, wherein the extension is configured to not substantially enter the ear canal.

41. A device comprising an earpiece and an extension that extends from the earpiece, the extension being configured to be in an ear canal and the earpiece being configured to be in a conchae.

42. The device as recited in claim 41, wherein the earpiece is configured to tend to keep the earpiece in the ear canal.

43. The device as recited in claim 41, wherein the earpiece defines, at least in part, a position of a distal end of the extension with respect to a wearer's eardrum.

44. The device as recited in claim 41, wherein the earpiece and the extension are configured to facilitate communication of sound to a wearer's eardrum.

45. The device as recited in claim 41, wherein the earpiece and the extension are configured to mitigate communication of sound to a wearer's eardrum.

46. The device as recited in claim 41, wherein the earpiece and the extension are configured to transmit voice to a wearer's eardrum.

47. The device as recited in claim 41, further comprising a bore formed in the extension for communicating sound to a wearer's eardrum.

48. The device as recited in claim 41, further comprising a bore formed in the extension for communicating sound to a wearer's eardrum and a Hochs filter configured to mitigate sound communicated though the bore.

49. The device as recited in claim 41, wherein the earpiece and the filter are configured to inhibit communication of sound exceeding 80 dB to a wearer's eardrum.

50. The device as recited in claim 41, wherein the extension substantially enters the ear canal.

51. The device as recited in claim 41, wherein the extension does not substantially enter the ear canal.

52. A device comprising:
two earpieces;
an extension extending from each earpiece; and
a lanyard interconnecting the two earpieces.

53. The device as recited in claim 52. wherein both extensions are configured to mitigate sound exposure.

54. The device as recited in claim 52. wherein at least one extension is configured to transmit sound therethrough.
